(19) United States
(12) Patent Application Publication
(10) Pub. No.: US 2025/0170830 A1
(43) Pub. Date: May 29, 2025

(54) LIQUID EJECTION DEVICE, CONTROL METHOD THEREOF, AND NON-TRANSITORY COMPUTER-READABLE RECORDING MEDIUM THEREFOR

(71) Applicant: BROTHER KOGYO KABUSHIKI KAISHA, Nagoya (JP)

(72) Inventor: Yasunari YOSHIDA, Ama (JP)

(21) Appl. No.: 18/962,227

(22) Filed: Nov. 27, 2024

(30) Foreign Application Priority Data
Nov. 29, 2023 (JP) 2023-201467

(51) Int. Cl. B41J 2/21; B41J 2/045

(52) U.S. Cl. CPC B41J 2/2132; B41J 2/04573

(57) ABSTRACT

A printing apparatus comprises a supply tray, a head having nozzles, a moving device configured to move the head, a conveying device, a cutter, and a controller. The controller performs a first printing process including a first pass operation to eject ink while moving the head and a first conveyance operation to convey the printing medium by a first conveyance amount. A first pass area of the printing medium in a current recording process is overlaid on the first pass area in a previous recording process. The controller is configured to perform a cutting process of cutting the printing medium, and a correction process of correcting the first conveyance amount in such a manner that a downstream end of the first pass area faces a downstream end of the nozzle range. The cutter is configured to cut the printing medium after the correction process is performed.

### RREFERENCE TO RELATED APPLICATIONS

This application is a continuation application was filed claiming priority from Japanese Patent Application No. 2023-201467 filed on Nov. 29, 2023. The entire content of the priority application is incorporated herein by reference.

### BACKGROUND ART

The present disclosure relates to a liquid ejection device which is configured such that a roller is arranged on a downstream side in a sheet conveying direction with respect to a head. The present disclosure also relates to a control method of controlling such a liquid ejection device, and a non-transitory computer-readable recording medium contacting computer-executable instructions for such a liquid ejection device.

Conventionally, there has been known a recording apparatus, which may employ the liquid ejection device as mentioned above, including a driven roller configured to be rotated by a sheet which is conveyed in a sheet conveying direction and is arranged on a downstream side in the sheet conveying direction with respect to a printing head.

### SUMMARY

Since the driven roller is arranged downstream with respect to the head in the sheet conveying direction, a problem may arise where liquid that has landed from the head to the recording media may be transferred to the roller (and, in turn, the liquid on the roller may be transferred to the recording media). In typical conventional technology, the above problem can be suppressed to some extent by including a spur roller with multiple teeth on the periphery of the driven roller. However, the above problem may not be suppressed sufficiently, especially when the amount of liquid ejected to the printing medium is large.

According to aspect of the present disclosures, there is provided a liquid ejection device, comprises a head having multiple nozzles, a conveying mechanism configured to convey a printing medium in a conveying direction, the conveying mechanism having a roller arranged downstream with respect to the head in the conveying direction, and a controller. The controller is configured to perform a recording process of ejecting an ink droplet from the multiple nozzles for multiple recording areas aligned in the conveying direction of the printing medium, the recording process including x times of recording steps executed at time intervals for each of the multiple recording areas, x being a natural number greater than or equal to 2, a conveying process of conveying the printing medium toward the roller in the conveying direction by the conveying mechanism after performing the recording process. The controller is further configured to perform a first determination process of determining a standby time for a first recording step based on an amount of ink ejected from the multiple nozzles for a recording area in the first recording step, and a conveying time of the printing medium by the conveying mechanism from the recording area to the roller in the first recording step, a second determination process of determining a tentative standby time for a n-th recording step based on an amount of the ink ejected from the multiple nozzles for a recording area in the n-th recording step, and a conveyance time of the printing medium by the conveying mechanism from the recording area to the roller in the n-th recording step, n-th being 2nd to x-th, and a third determination process of determining a longer time from between the tentative standby time for the n-th recording step and a time obtained by subtracting a time from an end of a (n−1)-th recording step to an end of the n-th recording step from a standby time for the (n−1)-th recording step. The conveying process is performed after the standby time for a x-th recording step has elapsed from end of the x-th recording step.

According to aspect of the present disclosures, there is provided a control method for a liquid ejection device comprising a head having multiple nozzles, a conveying mechanism configured to convey a printing medium in a conveying direction, the conveying mechanism having a roller arranged downstream with respect to the head in the conveying direction, and a controller. The method of controlling the liquid ejection device comprises a recording process of ejecting an ink droplet from the multiple nozzles for multiple recording areas aligned in the conveying direction of the printing medium, the recording process including x times of recording steps executed at time intervals for each of the multiple recording areas, x being a natural number greater than or equal to 2, a conveying process of conveying the printing medium toward the roller in the conveying direction by the conveying mechanism after performing the recording process. The controller is further configured to perform a first determination process of determining a standby time for a first recording step based on an amount of ink ejected from the multiple nozzles for a recording area in the first recording step, and a conveying time of the printing medium by the conveying mechanism from the recording area to the roller in the first recording step, a second determination process of determining a tentative standby time for a n-th recording step based on an amount of the ink ejected from the multiple nozzles for a recording area in the n-th recording step, and a conveyance time of the printing medium by the conveying mechanism from the recording area to the roller in the n-th recording step, n-th being 2nd to x-th, and a third determination process of determining a longer time from between the tentative standby time for the n-th recording step and a time obtained by subtracting a time from an end of a (n−1)-th recording step to an end of the n-th recording step from a standby time for the (n−1)-th recording step. The conveying process is performed after the standby time for a x-th recording step has elapsed from end of the x-th recording step.

According to aspect of the present disclosures, there is provided a non-transitory computer-readable recording medium containing computer-executable instructions that are executable by a controller of a liquid ejection device. The liquid ejection device comprises a head having multiple nozzles, and a conveying mechanism configured to convey a printing medium in a conveying direction, the conveying mechanism having a roller arranged downstream with respect to the head in the conveying direction. The computer-executable instructions is configured to, when executed by the controller, cause the liquid ejection device to perform a recording process of ejecting an ink droplet from the multiple nozzles for multiple recording areas aligned in the conveying direction of the printing medium, the recording process including x times of recording steps executed at time intervals for each of the multiple recording areas, x being a natural number greater than or equal to 2, a conveying process of conveying the printing medium toward the roller in the conveying direction by the conveying mechanism after performing the recording process. The controller is further configured to perform a first determination process of determining a standby time for a first recording step based on an amount of ink ejected from the multiple nozzles for a recording area in the first recording step, and a conveying time of the printing medium by the conveying mechanism from the recording area to the roller in the first recording step, a second determination process of determining a tentative standby time for a n-th recording step based on an amount of the ink ejected from the multiple nozzles for a recording area in the n-th recording step, and a conveyance time of the printing medium by the conveying mechanism from the recording area to the roller in the n-th recording step, n-th being 2nd to x-th, and a third determination process of determining a longer time from between the tentative standby time for the n-th recording step and a time obtained by subtracting a time from an end of a (n−1)-th recording step to an end of the n-th recording step from a standby time for the (n−1)-th recording step. The conveying process is performed after the standby time for a x-th recording step has elapsed from end of the x-th recording step.

### BRIEF DESCRIPTION OF DRAWINGS

FIG. 1 is a plan view showing an entire configuration of a printer according to an embodiment of aspects of the present disclosure.

FIG. 2 is a cross-sectional view of a head included in the printer shown n FIG. 1.

FIG. 3 is a block diagram showing an electrical configuration of the printer shown I FIG. 1.

FIG. 4 is a flowchart illustrating a process performed by a CPU of the printer.

FIG. 5 schematically illustrates a moving operation executed by a program shown in FIG. 4.

FIG. 6A schematically illustrates the moving operation continuously performed by the program shown in FIG. 4.

FIG. 6B schematically illustrates another example of the moving operation continuously performed by the program shown in FIG. 4.

Fug. 7 shows a table illustrating a standby time and a tentative standby times for an n-th moving operation.

FIG. 8 is a graph illustrating a function of an ejection duty in a high image quality mode according to a modification of the present embodiment.

### DESCRIPTION

### Embodiment

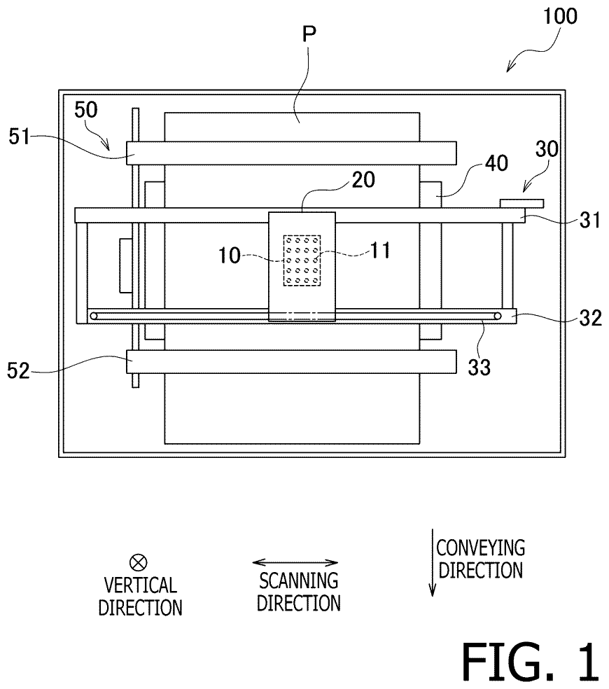

In FIG. 1, a printer 100 according to an embodiment of the present disclosure is shown. The printer 100 includes a head 10 that has multiple nozzles 11 formed on a lower surface thereof, a carriage 20 holding the head 10, a moving mechanism 30 configured to move the carriage 20 and the head 10 in a moving direction, a platen 40 configured to support a printing sheet P from below, a conveying mechanism 50 configured to convey the printing sheet P in a conveying direction, and a controller 90. The printing sheet P may be a “printing medium” according to aspects of the present disclosure. It is noted that the moving direction, the conveying direction and a vertical direction are orthogonal to each other.

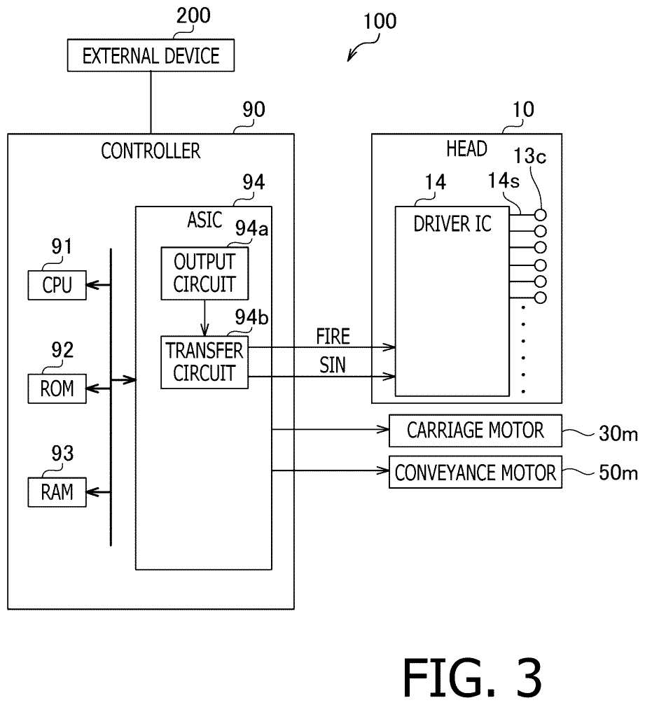

The moving mechanism 30 includes guides 31 and 32 supporting the carriage 20 and a belt 33 connected with the carriage 20. The guides 31 and 32, and the belt 33 extend in the moving direction. When the controller 90 drives a carriage motor 30m (see FIG. 3), the belt 33 runs, thereby the carriage 20 and the head 10 move guided by the guides 31 and 32.

The platen 40 is arranged below the carriage 20 and the head 10. On an upper surface of the platen 40, the sheet P is supported.

The conveying mechanism 50 has an upstream roller 51 arranged upstream, in the conveying direction, with respect to the head 10, and a downstream roller 52 arranged downstream, in the conveying direction, with respect to the head 10. Each of the upstream roller 51 and the downstream roller 52 has two rotating members. The two rotating members has an upper side rotating member arranged on an upper side with respect to a conveying path of the sheet P, and a lower side rotating member arranged on a lower side with respect to the conveying path of the sheet P. The upper side rotating member and the lower side rotating member are arranged such that their peripheral surfaces contact each other with or without the sheet P.

One or both of the two rotating members of the downstream roller 52 may be an example of a “roller” according to aspects of the present disclosure. One or each of the two rotating members of the downstream roller 52 may have a spur roller formed with multiple protrusions around its circumferential surface, or a cylindrical roller made of rubber or the like without such protrusions. Between, in the conveying direction, the upstream roller 51 and the downstream roller 52, the head 10, the carriage 20 and the platen 40 are arranged.

When the controller 90 drives the conveying motor 50m (see FIG. 3), each rotating member of the upstream roller 51 and the downstream roller 52 rotates. As each rotating member of the upstream roller 51 and the downstream roller 52 rotates with holding the sheet P, the sheet P is conveyed in the conveying direction.

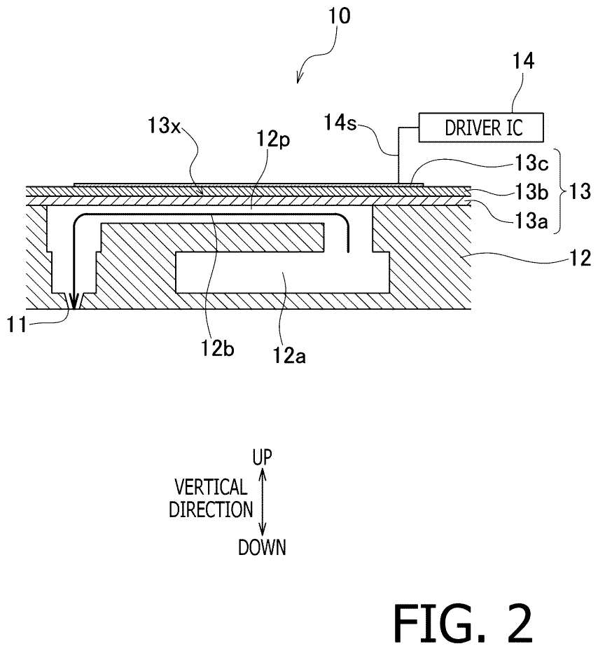

The head 10 has a flow channel unit 12 and an actuator unit 13, as shown in FIG. 2.

Multiple nozzles 11 (see FIG. 1) are formed on the bottom surface of the flow channel unit 12.

Inside the flow channel unit 12, a common flow channel 12a is connected to an ink tank (not shown), and individual flow channels 12b are formed for respective nozzles 11. The individual flow channel 12b is a flow path of the ink extending from an outlet of the common flow channel 12a through a pressure chamber 12p to the nozzle 11. Multiple pressure chambers 12p are opened on the upper surface of the flow channel unit 12.

The actuator unit 13 has multiple metal vibrating plates 13a, multiple piezoelectric layers 13b, and multiple individual electrodes 13c. The multiple metal vibrating plates 13a are arranged on the upper surface of the flow channel unit 12 to cover the multiple pressure chambers 12p, respectively. The piezoelectric layers 13b are arranged on upper surfaces of the vibrating plates 13a, respectively. The multiple individual electrodes 13c are arranged on upper surfaces of the piezoelectric layers 13b to face the multiple pressure chambers 12p, respectively.

The vibrating plates 13a and the multiple individual electrodes 13c are electrically connected to a driver IC 14. The driver IC 14 maintains the potential of each of the vibrating plates 13a at ground potential, while changing the potential of each of the individual electrodes 13c. Concretely, the driver IC 14 generates drive signals based on the control signals (i.e., waveform signal FIRE and selection signal SIN) from the controller 90, and supplies the drive signals to the multiple individual electrodes 13c via signal lines 14s, respectively. In this way, the potential of each individual electrode 13c changes between a particular drive potential (VDD) and the ground potential (0V). A diaphragm 13a and a portion, in the piezoelectric layer 13b, sandwiched between the individual electrodes 13c and the pressure chambers 12p (i.e., an actuator 13x) is deformed, which changes the volume of the pressure chamber 12p and applies pressure to the ink in the pressure chamber 12p, causing the nozzle 11 to eject the ink. The actuators 13x are provided for respective individual electrodes 13c (i.e., for respective nozzles 11) and can be independently deformed according to the electric potential supplied to each of the individual electrodes 13c.

As shown in FIG. 3, the controller 90 has a CPU (Central Processing Unit) 91, a ROM (Read Only Memory) 92, a RAM (Random Access Memory) 93, and an ASIC (Application Specific Integrated Circuit (ASIC) 94. The CPU 91 and the ASIC 94 may be a “controller” according to aspects of the present disclosure.

The ROM 92 stores programs and data for the CPU 91 or the ASIC 94 to perform various controls. The RAM 93 temporarily stores data (i.e., image data) to be used by the CPU 91 or the ASIC 94 when the programs are executed. The controller 90 is communicatively connected to an external device (e.g., a personal computer) 200, and based on data input from the external device 200 or the input section of the printer 100 (i.e., switches and buttons on the exterior of the printer 100 housing), the CPU 91 and the ASIC 94 perform recording and conveying processes.

As shown in FIG. 3, the ASIC 94 has an output circuit 94a and a transfer circuit 94b.

The output circuit 94a generates the waveform signal FIRE and the selection signal SIN, and outputs these signals to the transfer circuit 94b at each recording cycle. The recording cycle is a time required for the sheet of paper P to move relative to the head 10 by a unit distance corresponding to the resolution of the image formed on the sheet of paper P, which corresponds to one pixel.

The waveform signal FIRE is a serial signal which is a series of four pieces of waveform data respectively corresponding to “zero (no ejection),” “small,” “medium,” and “large” amounts of ink droplets ejected from one nozzle 11 in one recording cycle, and the numbers of pulses of the four pieces of waveform data are different from each other.

The selection signal SIN is a serial signal containing selection data to select one of the above four pieces of waveform data, and is generated for each actuator 13x and for each recording cycle based on the image data contained in the recording command.

The transfer circuit 94b transfers the waveform signal FIRE and the selection signal SIN received from the output circuit 94a to the driver IC 14. The transfer circuit 94b has a built-in LVDS (Low Voltage Differential Signaling) driver corresponding to each of the above signals, and transfers each signal to the driver IC14 as a pulse-shaped differential signal.

In the recording process, the ASIC 94 controls the driver IC 14 to generate drive signals, based on the waveform signal FIRE and the selection signal SIN, for respective pixels, and to supply the drive signals to the individual electrodes 13c via the signal lines 14s. In this way, the ASIC 94 makes, for each pixel, each of the multiple nozzles 11 eject an ink droplet corresponding to a selected one of four different ink amounts (zero, small, medium, and large) onto the sheet P.

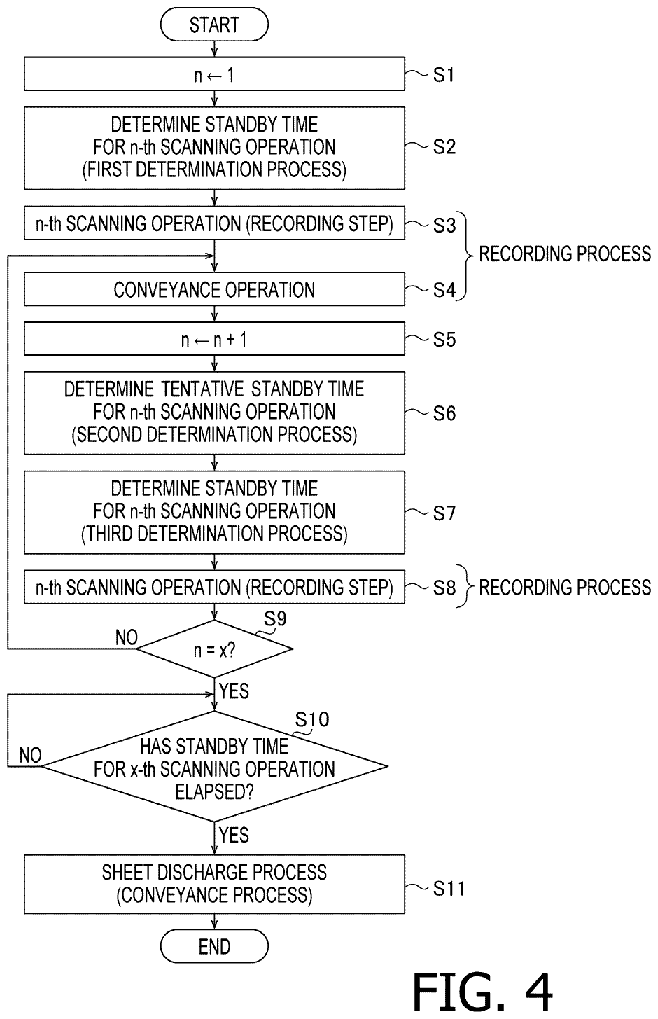

Referring next to FIG. 4, a program executed by the CPU 91 will be described. The program is executed after the controller 90 receives a recording command from the external device 200 or any other device.

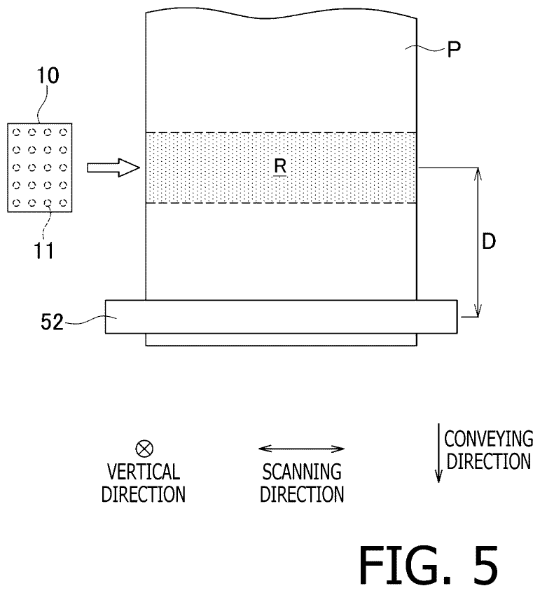

The CPU 91 performs the recording process by driving the driver IC 14, the carriage motor 30m, and the conveying motor 50m (see FIG. 3) via the ASIC 94 based on the recording command. In the recording process, a moving operation (i.e., a recording step) in which ink droplets are ejected from the multiple nozzles 11 for a recording area R (see FIG. 5) of the sheet P while the carriage 20 and head 10 are moved in the moving direction, and a conveyance operation in which the sheet P is conveyed by a particular amount in the conveying direction, are performed alternately. In this way, dots of ink are formed on the sheet P and an image is recorded thereon.

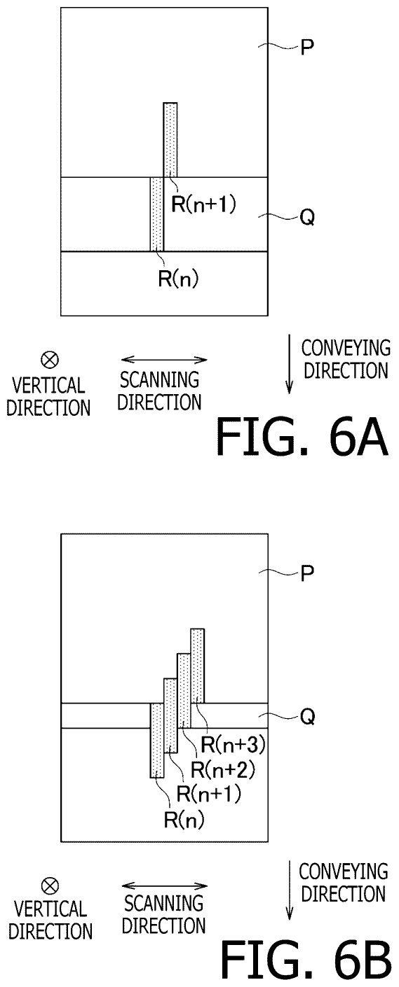

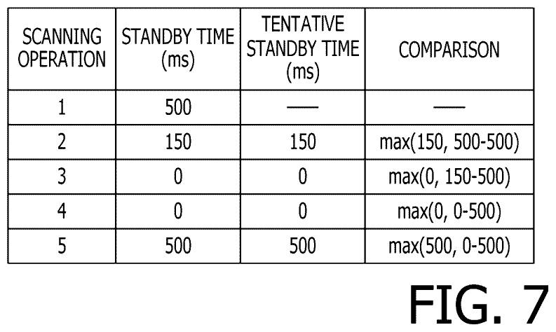

The recording area R is a rectangular area extending in the moving direction and corresponding to a portion of the sheet P. The recording area R corresponds to one moving operation (i.e., the recording step). In the recording process, the moving operation (i.e., the recording steps) are sequentially performed for respective recording areas R (see FIG. 6A and FIG. 6B) that are aligned in the conveying direction on the sheet P. The recording process includes x times of moving operations (i.e., recording steps) executed at time intervals for each of the multiple recording areas R, where x is a natural number greater than or equal to 2.

In FIG. 6A and FIG. 6B, for ease of understanding, the length in the moving direction of each recording area R that occupies the entire width (length in the moving direction) of the sheet P is shown shorter, and the multiple recording areas R are shown shifted in the moving direction.

In the example shown in FIG. 6A, a recording area R (n) corresponding to an n-th moving operation and a recording area R (n+1) corresponding to an (n+1)-th moving operation do not overlap with each other but are adjacent to each other in the conveying direction, where n is a natural number. In the example shown in FIG. 6A, one moving operation (i.e., one recording step) is performed on an unit area Q (i.e., an area corresponding to a particular amount of conveyance movement) of the sheet P. In such a case, the unit area Q coincides with the recording area R corresponding to one moving operation.

In the example shown in FIG. 6B, the recording area R (n) corresponding to the n-th moving operation and the recording area R (n+1) corresponding to the (n+1)th moving operation have overlapping areas with respect to each other. In the example shown in FIG. 6B, three moving operations (i.e., three recording steps) are performed on the unit area Q of the sheet P. In other words, ink ejected in the n-th moving operation, ink ejected in the (n+1)-th moving operation, and ink ejected in the (n+2)-th moving operation are all landed on the unit area Q. In such a case, the length of the unit area Q in the conveying direction is ⅓ of the length of the recording area R in the conveying direction corresponding to one moving operation.

The CPU 91 sets n to one (i.e., n=1) in S1 as shown in FIG. 4.

After execution of S1, the CPU 91 determines a standby time for an n-th (i.e., 1st) moving operation (S2: first determination process). The CPU 91 stores the determined standby time in the RAM 93.

In S2, the CPU 91 determines the standby time for the n-th (i.e., 1st) moving operation based on the amount of ink ejected from the multiple nozzles 11 for the recording area R in the n-th (i.e., 1st) moving operation, as indicated by the image data included in the recording command, and the conveying time of the sheet P by the conveying mechanism 50 from the recording area R to the downstream roller 52 (i.e., the time required to convey the sheet P by a distance shown in FIG. 5D). The CPU 91 stores the determined standby time in the RAM 93. For example, the standby time is longer for a larger amount of ink above and longer for a shorter conveying time above.

Further, in S2, the CPU 91 determines the standby time based on either a first reference time T1 or a second reference time T2, depending on whether the recording mode indicated by the recording command is a normal-speed mode or a high-speed mode.

When the recording mode indicated by the recording command is the normal-speed mode, each of x times of moving operations is performed such that the head 10 is moved at a first speed V1 in the moving direction while the ink is ejected from the multiple nozzles 11 for the corresponding recording area R. When the recording mode indicated by the recording command is the high-speed mode, each of x times moving operations is performed such that the head 10 is moved at a second speed V2 in the moving direction while the ink is ejected from the multiple nozzles 11 for the corresponding recording area R. It is noted that the second speed V2 is higher than the first speed V1. That is, the x times of moving operations are executed in such a manner that the head 10 is moved in the moving direction at the first speed V1 or the second speed V2, while the ink is ejected from the multiple nozzles 11 for the corresponding recording area R.

The first reference time T1 and the second reference time T2 are stored in the ROM 92 (see FIG. 3), which may be an example of a storage according to aspects of the present disclosure. The second reference time T2 is shorter than the first reference time T2 (i.e., T2<T1). For example, the first reference time T1 may be 500 ms and the second reference time T2 may be 300 ms.

The maximum amount per unit area of an ink droplet ejected from one of the multiple nozzles 11 in the normal-speed mode is greater than the maximum amount per unit area of the ink droplet ejected from one of the multiple nozzles 11 in the high-speed mode. That is, in the high-speed mode, relatively small ink droplets are ejected.

In S2, in the normal-speed mode, the CPU 91 determines the standby time based on the first reference time T1, while, in the high-speed mode, the CPU 91 determines the standby time based on the second reference time T2. For example, if conditions other than the recording mode are the same, the standby time is longer in the normal-speed mode than in the high-speed mode.

After S2, the CPU 91 executes the n-th (i.e., 1st) moving operation (i.e., the recording step), in which the ink is ejected from the nozzles 11 to the recording area R (see FIG. 5) while moving the carriage 20 and head 10 in the moving direction (S3).

After S3, the CPU 91 executes a conveyance operation to convey the sheet P by a particular amount in the conveying direction with the conveying mechanism 50 (S4).

After S4, the CPU 91 increments n by one (i.e., n=n+1) in S5.

After S5, the CPU 91 determines a tentative standby time for the n-th (n-th being 2nd to x-th) moving operation (S6: second determination process), and the CPU 91 stores the determined tentative standby time in the RAM 93.

In S6, the CPU 91 determines a tentative standby time for the n-th (n-th being 2nd to x-th) moving operation based on the amount of the ink ejected from the multiple nozzles 11 for the recording area R in the n-th (n-th being 2nd to x-th) moving operation, as indicated by the image data included in the recording command, and the conveyance time of the sheet P by the conveying mechanism 50 from the recording area R to the downstream roller 52 (i.e., the time required to convey the sheet P by a distance D as shown in FIG. 5). The CPU 91 stores the determined tentative standby time in the RAM 93. For example, the longer the amount of the ink ejected from the nozzles 11, the longer the tentative standby time, and the shorter the conveyance time, the longer the tentative standby time.

Further, in S6, the CPU 91 determines the tentative standby time based on either the first reference time T1 or the second reference time T2, depending on whether the recording mode indicated by the recording command is the normal-speed mode or the high-speed mode. In the case of the normal-speed mode, the CPU 91 determines the tentative standby time based on the first reference time T1, while in the case of the high-speed mode, the CPU 91 determines the tentative standby time based on the second reference time T2. Therefore, for example, if other conditions are the same except for the recording mode, the standby time is longer in the normal-speed mode than in the high-speed mode.

After S6, the CPU 91 determines the standby time for the n-th (n-th being 2nd to x-th) moving operation (S7: third determination process).

In S7, the CPU 91 determines, as the standby time for the n-th moving operation, a longer time from between the tentative standby time for the n-th moving operation and the time obtained by subtracting a time from the standby time for the (n−1)-th moving operation to the end of the n-th moving operation from the end of the (n−1)-th moving operation. At this time, the CPU 91 stores, in the RAM 93, the longer time of the tentative standby time for the n-th moving operation and a time obtained by subtracting the time from the end of the (n−1)-th moving operation to the end of the n-th moving operation from the standby time for the (n−1)-th moving operation, while the CPU 91 deletes, from the RAM 93, a shorter time of the tentative standby time for the n-th moving operation and a time obtained by subtracting the time from the end of the (n−1)-th moving operation to the end of the n-th moving operation from the standby time for the (n−1)-th moving operation.

After S7, the CPU 91 executes the n-th (n-th being 2nd to x-th) moving operation (i.e., recording step) in S8.

After S8, the CPU 91 determines whether n is equal to x (i.e., n-th=x-th) in S9.

If n is not equal to x (S9: NO), the CPU 91 returns to S4 and perform the processes from S5 onward again.

The standby time that is determined for each moving operation (i.e., the recording step) will be described in detail, referring to FIG. 7.

In an example shown in FIG. 7, the standby time for the first moving operation is determined to be 500 ms (S2) based on the amount of the ink droplet to be ejected from the multiple nozzles 11 for the relevant recording area R in the first moving operation.

The tentative standby time for the second moving operation is determined to be 150 ms (S6) based on the amount of ink ejected from the multiple nozzles 11 for the relevant recording area R in the second moving operation. The standby time for the second moving operation is determined to be the longer time (150 ms) of the tentative standby time for the second moving operation (150 ms) and a time (0 ms) obtained by subtracting the time from the end of the first moving operation to the end of the second moving operation (500 ms) from the standby time for the first moving operation (500 ms) (S7).

The tentative standby time for the third moving operation is determined to be 0 ms (S6) based on the amount of ink ejected from the multiple nozzles 11 for the relevant recording area R in the third moving operation. The standby time for the third moving operation is determined to be the longer time (0 ms) of the tentative standby time for the third moving operation (0 ms) and a time (−350 ms) obtained by subtracting the time from the end of the second moving operation to the end of the third moving operation (500 ms) from the standby time for the second moving operation (150 ms) (S7).

The tentative standby time for the fourth moving operation is determined to be 0 ms (S6) based on the amount of ink ejected from the multiple nozzles 11 for the relevant recording area R in the fourth moving operation. The standby time for the fourth moving operation is determined to be the longer time (0 ms) of the tentative standby time for the fourth moving operation (0 ms) and a time (−500 ms) obtained by subtracting the time from the end of the third moving operation to the end of the fourth moving operation (500 ms) from the standby time for the third moving operation (0 ms) (S7).

The tentative standby time for the fifth moving operation is determined to be 500 ms based on the amount of ink ejected from the multiple nozzles 11 for the relevant recording area R in the fifth moving operation (S6). The standby time for the fifth moving operation is determined to be the longer time (500 ms) of the tentative standby time for the fifth moving operation (500 ms) and the time (−500 ms) obtained by subtracting the time from the end of the fourth moving operation to the end of the fifth moving operation (500 ms) from the standby time for the fourth moving operation (0 ms) (S7).

If n=x (S9: YES), the CPU 91 determines whether or not the standby time for the x-th moving operation has elapsed from the end of the x-th moving operation (S10).

If it is determined that the standby time for the x-th moving operation has not elapsed since the end of the x-th moving operation (S10: NO), the CPU 91 repeats the process in S10.

If it is determined that the standby time for the x-th moving operation has elapsed since the end of the x-th moving operation (S10: YES), the CPU 91 performs a sheet discharge process (S11) and then terminates the program.

In S11, the CPU 91 controls the conveying mechanism 50 to convey the sheet P in the conveying direction towards the downstream roller 52 with a conveyance amount greater than a particular amount of conveyance. As a result, the recording area R corresponding to the n-th (n-th being 1st to x-th) moving operation successively reaches the downstream roller 52.

In the program illustrated in FIG. 4, the processes at S3 and S4, and the processes from S8, S9: NO, and then to S4, may correspond to a “recording process,” and a process in S11 may correspond to a “conveying process” according to aspects of the present disclosure.

As described above, according to the present embodiment, for each of second and subsequent moving operations (i.e., the recording steps), a tentative standby time is determined (S6) and the standby time for the current moving operation (recording step) is determined (S7) based on that tentative standby time and the standby time of the previous moving operation (i.e., the previous recording step). After the standby time for the x-th moving operation (i.e., the recording step) has elapsed from the end of the x-th moving operation (i.e., the recording step), the sheet discharge process (conveyance process) is performed (S10: YES, S11). In such a case, when each recording area R reaches the downstream roller 52, the ink that has landed on each recording area R has been in a dried state and the problem of the ink adhering to the downstream roller 52 can be suppressed.

The reference times T1 and T2 used in the determination process (S2) of the standby time for the first moving operation and the determination process (S6) of the tentative standby time for the n-th (i.e., 2nd to x-th) moving operation differ between the normal-speed mode and the high-speed mode. In this way, the standby time in which the problem of ink that has landed on the sheet P adhering to the downstream roller 52 is suppressed can be determined appropriately.

The maximum amount per unit area of an ink droplet ejected from one of the multiple nozzles 11 in the normal-speed mode is greater than the maximum amount per unit area of an ink droplet ejected from one of the multiple nozzles 11 in the high-speed mode. The higher the maximum amount of the ink droplet, the longer it takes for the ink to dry after it has landed on the sheet P. Therefore, in the normal-speed mode, where the maximum amount of the ink droplets per unit area is larger, the standby time for the first moving operation (S2) and the tentative standby time for each of the n-th (i.e., 2nd to x-th) moving operations (S6) is determined based on the first reference time T1 (which is longer than the second reference time T2). In this way, it is possible to determine the standby time for suppressing the problem of ink landing on paper P and sticking to the downstream roller 52 more appropriately.

In the embodiment explained above, S2 and S6 are executed based on the different reference times T1 and T2 in the normal-speed mode and high-speed mode. On the other hand, in a first modification of the embodiment, S2 and S6 are executed based on the different reference times T1 and T2 in a normal image quality mode and a higher image quality mode. The reference time T1 of the embodiment and the reference time T1 of the first modification may be different from each other or the same. The reference time T2 of the embodiment and the reference time T2 of the modification may be different from each other or the same.

The first reference time T1 and the second reference time T2 are stored in the ROM 92 (see FIG. 3) that may be an example of a “storage” according to aspects of the present disclosure. The second reference time T2 is shorter than the first reference time T1 (i.e., T2<T1). For example, the first reference time T1 may be 500 ms, and the second reference time T2 may be 250 ms.

In S2, the CPU 91 determines the standby time based on either the first reference time T1 or the second reference time T2, depending on whether the recording mode indicated by the recording command is the normal image quality mode or the high image quality mode. In the case of normal image quality mode, the CPU 91 determines the standby time based on the first reference time T1, while in the case of high image quality mode, the CPU 91 determines the standby time based on the second reference time T2. For example, if the conditions are the same except for the recording mode, the standby time is longer in the normal image quality mode than in the high image quality mode.

In S6, the CPU 91 determines the tentative standby time based on either the first reference time T1 or the second reference time T2, depending on whether the recording mode indicated by the recording command is the normal image quality mode or the high image quality mode. In the case of normal image quality mode, the CPU 91 determines the tentative standby time based on the first reference time T1, while in the case of high image quality mode, the CPU 91 determines the tentative standby time based on the second reference time T2. For example, if the conditions are the same except for the recording mode, the standby time is longer in the normal image quality mode than in the high image quality mode.

In the case of the normal image quality mode, the recording process is such that, as shown in FIG. 6A, the moving operation (i.e., the recording step) is performed a times (a being one in the present embodiment) for a unit area Q (an area corresponding to a particular amount of conveyance operation) of the sheet P.

In the case of the high image quality mode, the recording process is such that, as shown in FIG. 6B, the moving operation (i.e., the recording step) is performed b times (b being three in the present embodiment) for the unit area Q of the sheet P. Both a and b are natural numbers and a is smaller than b.

The maximum amount of an ink droplet per unit area ejected from one of the multiple nozzles 11 in the normal image quality mode is greater than the maximum amount of an ink droplet per unit area ejected from one of the multiple nozzles 11 in the high image quality mode. In other words, relatively small ink droplets are ejected in the high image quality mode.

In the high image quality mode, the CPU 91 causes the head 10 to selectively eject ink from the multiple nozzles 11 based on data which image data decomposed into complementary patterns for each moving operation.

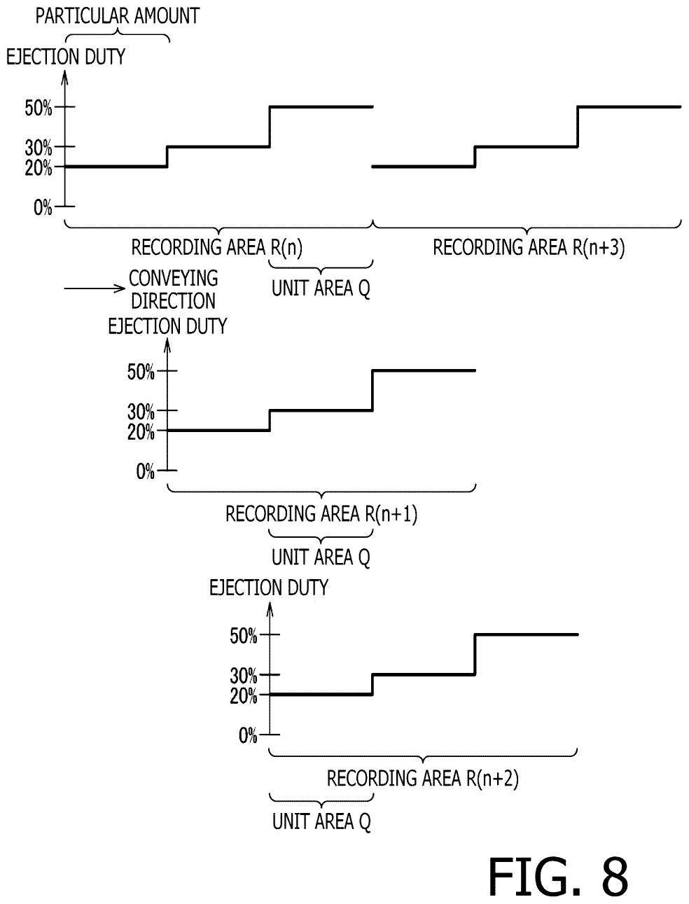

Concretely, as shown in FIG. 8, the image data indicating the amount of ink to be dispensed for a unit area Q (an area corresponding to a particular amount of conveyance movement) is decomposed into complementary patterns of part of the image data for the recording area R (n) corresponding to the n-th moving operation, part of the image data for the recording area R (n+1) corresponding to the (n+1)-th moving operation, and part of the image data for the recording area R (n+2) corresponding to the (n+2)-th moving operation.

For each moving operation, an ejection duty for the recording area R varies in three steps from 20%, 30% and 50% from the upstream side to the downstream side in the conveying direction.

The ejection duty for the unit area Q is the sum of the ejection duty of 50% for the n-th moving operation, the ejection duty of 30% for the (n+1)-th moving operation, and the ejection duty of 20% for the (n+2)-th moving operation, which totals 100%. The ejection duty of 20% in the (n+2)-th moving operation for the unit area Q is lower than the ejection duty of 30% in the (n+1)-th moving operation for the unit area Q. The ejection duty of 30% in the (n+1)-th moving operation for the unit area Q is lower than the ejection duty of 50% in the n-th moving operation for the unit area Q.

As described above, in the present embodiment, the reference times T1 and T2 used in the processes for determining the standby time for the first moving operation (S2) and the tentative standby time for the n-th (n-th being 2nd to x-th) moving operation (S6) differ between the normal image quality mode and the high image quality mode. In this way, it is possible to determine an appropriate standby time that can suppress the problem of ink landing on the sheet P and sticking to the downstream roller 52.

The maximum amount of an ink droplet per unit area ejected from one of the multiple nozzles 11 in the normal image quality mode is greater than the maximum amount of an ink droplet per unit area ejected from one of the multiple nozzles 11 in the high image quality mode. The larger the maximum is, the longer it takes for the ink to dry on the sheet P. Therefore, in the normal image quality mode, where the maximum amount is larger, the processing to determine the standby time for the first moving operation (S2) and the processing to determine the tentative standby time for the n-th (n-th being 2nd to x-th) moving operation (S6) are performed based on the first reference time T1 (which is longer than the second reference time T2). In this way, it is possible to determine standby times for suppressing the problem of ink landing on sheet P and sticking to the downstream roller 52 more appropriately.

In high image quality mode, the CPU 91 causes the head 10 to selectively eject the ink from the multiple nozzles 11 based on the data that decomposes the image data into a complementary pattern in each moving operation (see FIG. 8). In such a case, if one of the multiple nozzles 11 is a defective nozzle, the deterioration of image quality can be suppressed by supplementing the image with another nozzle corresponding to the position of the defective nozzle in a moving operation other than the moving operation in which the defective nozzle is used.

The ink ejected during the (n+2)-th (=α-th) moving operation will land on the sheet P later than the ink ejected during the (n+1)-th (=β-th) moving operation, and will be more difficult to dry as time passes. Therefore, in the present embodiment, the ejection duty of 20% in the (n+2)-th moving operation for the unit area Q is lower than the ejection duty of 30% in the (n+1)-th moving operation for the unit area Q (see FIG. 8). Further, the ink ejected in the (n+1)-th (α-th) moving operation will land on the sheet P later than the ink ejected in the n-th (β-th) moving operation, and therefore will be more difficult to dry over time. The present embodiment is configured such that the ejection duty of 30% in the (n+1)-th moving operation for the unit area Q is lower than the ejection duty of 50% in the n-th moving operation for the unit area Q (see FIG. 8). According to this configuration, the ink that lands on the sheet P dries more easily, and the problem of the ink landing on the sheet P sticking to the downstream roller 52 can be more reliably suppressed.

In the embodiment explained first, S2 and S6 are executed based on the reference times T1 and T2, which are different depending on whether the mode is the normal-speed mode or the high-speed mode. On the other hand, in a second modification, S2 and S6 are executed based on the reference times T1 and T2, which are different depending on the type of the sheet P. The reference time T1 of the embodiment and the reference time T1 of the second modification may be different from each other or the same. The reference time T2 of the embodiment and the reference time T2 of the second modification may be different from each other or the same.

The first reference time T1 and the second reference time are stored in the ROM 92 (see FIG. 3) that may be an example of a “storage” according to aspects of the present disclosure. In general, the rate of ink penetration is slower on glossy papers than on plain papers, and it takes longer for the ink to dry on the glossy papers than on the plain papers. Therefore, the first reference time T1 is set to be longer than the second reference time T2 (i.e., T1>T2). For example, the first reference time T1 may be 500 ms and the second reference time T2 may be 200 ms.

In S2, the CPU 91 determines the standby time based on either the first reference time T1 or the second reference time T2, depending on whether the sheet type indicated by the recording command is the glossy paper (type 1) or the plain paper (type 2). When the sheet type is the glossy paper, the CPU 91 determines the standby time based on the first reference time T1, while when the sheet type is the plain paper, the CPU 91 determines the standby time based on the second reference time T2. For example, if the conditions other than the sheet type are the same, the standby time is longer for the glossy paper than for the plain paper.

In S6, the CPU 91 determines the tentative standby time based on either the first reference time T1 or the second reference time T2, depending on whether the sheet type indicated by the recording command is the glossy paper (type 1) or the plain paper (type 2). When the sheet type is the glossy paper, the CPU 91 determines the tentative standby time based on the first reference time T1, while when the sheet type is the plain paper, the CPU 91 determines the tentative standby time based on the second reference time T2. For example, if the conditions other than the sheet type are the same, the tentative standby time is longer for the glossy paper than for the plain paper.

As described above, in the present embodiment, the reference times T1 and T2 used in the processes for determining the standby time for the first moving operation (S2) and the tentative standby time for the n-th (2 to x) moving operation (S6) differ depending on the type of the sheet P (difference in ink penetration speed). In this way, it is possible to appropriately determine the standby time to suppress the problem of ink that has landed on the paper P sticking to the downstream roller 52.

While aspects of the present disclosure has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of aspects of the present disclosure, and not limiting the same. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations according to aspects of the present disclosure are further provided below.

In the above embodiments, a distance between the center of the recording area and the center of the roller (see distance D in FIG. 5) is given as a distance from the recording area to the roller, but the distance from the recording area to the roller is not necessarily limited to this definition. For example, a distance from the upstream end of the recording area to the upstream end of the roller in the conveying direction, a distance from the downstream end of the recording area to the downstream end of the roller in the conveying direction, a distance from the downstream end of the recording area to the upstream end of the roller in the conveying direction, and a distance from the upstream end of the recording area to the downstream end of the roller in the conveying direction, etc., may be used as the distance from the recording area to the roller.

If there are multiple rollers downstream with respect to the head in the conveying direction, any of these rollers that are to be subject to the problem of an ink droplet landing on the printing medium sticking to them can be considered as the “roller” according to aspects of the present disclosure.

Factors that determine the standby time and tentative standby time may include the color of the ink droplet, the components of the ink droplet, the ambient temperature, and the ambient humidity.

In each determination process, a weight may be assigned to the amount of the ink droplet for the recording area according to a position in the moving direction. For example, when the multiple partial rollers that constitute the roller according to the present disclosure are arranged in the moving direction, a larger weight may be assigned to positions where the partial rollers are arranged in the moving direction than to other positions.

The program shown in FIG. 4 is based on the premise that the recording area corresponding to the first moving operation (i.e., the first recording step) does not reach the downstream roller 52 at the end of the x-th moving operation (i.e., the x-th recording step). If the recording area corresponding to the first moving operation (i.e., the first recording step) reaches the downstream roller 52 before the end of the x-th moving operation (i.e., the x-th recording step), it is sufficient to execute the sheet ejection process (i.e., the sheet conveyance process) after the standby time for the moving operation (i.e., the recording step) has elapsed from the end of the moving operation (i.e., the recording step) executed immediately before the recording area corresponding to the first moving operation (i.e., the first recording step) reaches the downstream roller 52.

In high image quality mode, the number of moving operations (i.e., the recording steps) is not limited to three times for the unit area Q of the sheet P (see FIG. 6B), but may be any number of times greater than or equal to two.

The head is serial type in the embodiments described above, but may also be line type.

The liquid ejected from the nozzles is not necessarily limited to an ink droplet, but may also be a liquid other than ink (for example, a processing liquid that causes the components in the ink to coagulate or precipitate).

The printing medium is not necessarily limited to sheets, but may also be, for example, cloth or resin members.

The program according to the present disclosure can be distributed by recording the same on a removable printing medium such as a flexible disk or a fixed printing medium such as a hard disk, or may be distributed via a communication line.

Aspects of the present disclosure may be applicable not only to printers, but also to facsimiles, copiers, MFPs, and other devices. Further, the aspects of the present disclosures are also applicable to liquid ejection devices used for purposes other than image recording (e.g., liquid ejection devices that eject conductive liquid onto a substrate to form a conductive pattern).

What is claimed is:

1. A liquid ejection device, comprising:
a head having multiple nozzles;
a conveying mechanism configured to convey a printing medium in a conveying direction, the conveying mechanism having a roller arranged downstream with respect to the head in the conveying direction; and
a controller,
wherein the controller is configured to perform:
a recording process of ejecting an ink droplet from the multiple nozzles for multiple recording areas aligned in the conveying direction of the printing medium, the recording process including x times of recording steps executed at time intervals for each of the multiple recording areas, x being a natural number greater than or equal to 2;
a conveying process of conveying the printing medium toward the roller in the conveying direction by the conveying mechanism after performing the recording process, and
wherein the controller is further configured to perform:
a first determination process of determining a standby time for a first recording step based on an amount of ink ejected from the multiple nozzles for a recording area in the first recording step, and a conveying time of the printing medium by the conveying mechanism from the recording area to the roller in the first recording step;
a second determination process of determining a tentative standby time for a n-th recording step based on an amount of the ink ejected from the multiple nozzles for a recording area in the n-th recording step, and a conveyance time of the printing medium by the conveying mechanism from the recording area to the roller in the n-th recording step, n-th being 2nd to x-th; and
a third determination process of determining a longer time from between the tentative standby time for the n-th recording step and a time obtained by subtracting a time from an end of a (n−1)-th recording step to an end of the n-th recording step from a standby time for the (n−1)-th recording step;
wherein the conveying process is performed after the standby time for a x-th recording step has elapsed from end of the x-th recording step.

2. The liquid ejection device according to claim 1,
wherein the recording step is a moving operation executed in such a manner that the head is moved in a moving direction at a first speed or a second speed faster than the first speed, while the ink is ejected from the multiple nozzles for the recording areas, the moving scanning direction intersecting the conveying direction,
wherein the liquid ejection device further comprises a storage configured to store a first reference time and a second reference time shorter than the first reference time, and
wherein the controller is configured to perform:
in a case where the moving operation is executed with the head moved at the first speed in each of multiple recording steps, determining the standby time for the first recording step based on the first reference time in the first determination process, and determining the tentative standby time for the n-th recording step based on the first reference time; and
in a case where the moving operation is executed with the head moved at the second speed in each of multiple recording steps, determining the standby time for the first recording step based on the second reference time in the first determination process, and determining the tentative standby time for the n-th recording step based on the second reference time.

3. The liquid ejection device according to claim 2,
wherein, in each of multiple recording steps, a maximum amount per unit area of the ink droplet ejected from one of the multiple nozzles in a case where the moving operation is executed with the head moved at the first speed is greater than a maximum amount per unit area of the ink droplet ejected from one of the multiple nozzles in a case where the moving operation is executed with the head moved at the second speed.

4. The liquid ejection device according to claim 1,
wherein the recording process including a or b times of recording steps for an unit area of the printing medium, a and b being natural numbers and a being smaller than b,
wherein the liquid ejection device further comprises a storage configured to store a first reference time and a second reference time shorter than the first reference time, and
wherein the controller is configured to perform:
in a case where the a times of the recording steps for the unit area are executed in the recording process, determining the standby time for the first recording step based on the first reference time in the first determination process, and determining the tentative standby time for the n-th recording step based on the first reference time; and
in a case where the b times of the recording steps for the unit area are executed in the recording process, determining the standby time for the first recording step based on the second reference time in the first determination process, and determining the tentative standby time for the n-th recording step based on the second reference time.

5. The liquid ejection device according to claim 4,
wherein a maximum amount of the ink droplet per unit area ejected from one of the multiple nozzles in a case where the a times of the recording steps for an unit area are executed in the recording process is greater than a maximum amount per unit area of the ink droplet ejected from one of the multiple nozzles in a case where the b times of the recording steps for the unit area are executed in the recording process.

6. The liquid ejection device according to claim 4,
wherein the controller is configured to cause the head to selectively eject ink from the multiple nozzles based on decomposed data in a case where multiple times of the recording steps for the unit area are executed in the recording process, the decomposed data being image data decomposed into complementary patterns for each of the recording steps.

7. The liquid ejection device according to claim 6,
wherein an ejection duty in a α-th recording step for the unit area is lower than an ejection duty in a β-th recording step for the unit area in a case where multiple times of the recording steps for the unit area are executed in the recording process, a being greater than B, the ejection duty being a ratio of an amount of ink ejected by the multiple nozzles to a amount of ink required to be ejected by the multiple nozzles based on the image data.

8. The liquid ejection device according to claim 1,
wherein the liquid ejection device further comprises a storage configured to store a first reference time and a second reference time shorter than the first reference time, and
wherein the controller is configured to perform:
in a case where the printing medium is a first type of sheet, determining the standby time based on the first reference time in the first determination process, and determining the tentative standby time based on the first reference time; and
in a case where the printing medium is a second type of sheet, the second type being a type that ink penetration speed is higher than ink penetration speed of the first type of sheet, determining the standby time based on the second reference time in the first determination process, and determining the tentative standby time based on the second reference time.

9. A control method for a liquid ejection device,
wherein the liquid ejection device comprises:
a head having multiple nozzles;
a conveying mechanism configured to convey a printing medium in a conveying direction, the conveying mechanism having a roller arranged downstream with respect to the head in the conveying direction; and
a controller,
wherein the method of controlling the liquid ejection device comprises:
a recording process of ejecting liquid from the multiple nozzles for multiple recording areas aligned in the conveying direction of the printing medium, the recording process including x times of recording steps executed at time intervals for each of the multiple recording areas, x being a natural number greater than or equal to 2;
a conveying process of conveying the printing medium toward the roller in the conveying direction by the conveying mechanism after performing the recording process, and
wherein the controller is further configured to perform:
a first determination process of determining a standby time for a first recording step based on an amount of ink ejected from the multiple nozzles for a recording area in the first recording step, and a conveying time of the printing medium by the conveying mechanism from the recording area to the roller in the first recording step;
a second determination process of determining a tentative standby time for a n-th recording step based on an amount of the ink ejected from the multiple nozzles for a recording area in the n-th recording step, and a conveyance time of the printing medium by the conveying mechanism from the recording area to the roller in the n-th recording step, n-th being 2nd to x-th; and
a third determination process of determining a longer time from between the tentative standby time for the n-th recording step and a time obtained by subtracting a time from an end of a (n−1)-th recording step to an end of the n-th recording step from a standby time for the (n−1)-th recording step;
wherein the conveying process is performed after the standby time for a x-th recording step has elapsed from end of the x-th recording step.

10. A non-transitory computer-readable recording medium containing computer-executable instructions that are executable by a controller of a liquid ejection device,
wherein the liquid ejection device comprises:
a head having multiple nozzles; and
a conveying mechanism configured to convey a printing medium in a conveying direction, the conveying mechanism having a roller arranged downstream with respect to the head in the conveying direction;
wherein the computer-executable instructions is configured to, when executed by the controller, cause the liquid ejection device to perform:
a recording process of ejecting liquid from the multiple nozzles for multiple recording areas aligned in the conveying direction of the printing medium, the recording process including x times of recording steps executed at time intervals for each of the multiple recording areas, x being a natural number greater than or equal to 2;
a conveying process of conveying the printing medium toward the roller in the conveying direction by the conveying mechanism after performing the recording process, and
wherein the controller is further configured to perform:
a first determination process of determining a standby time for a first recording step based on an amount of ink ejected from the multiple nozzles for a recording area in the first recording step, and a conveying time of the printing medium by the conveying mechanism from the recording area to the roller in the first recording step;
a second determination process of determining a tentative standby time for a n-th recording step based on an amount of the ink ejected from the multiple nozzles for a recording area in the n-th recording step, and a conveyance time of the printing medium by the conveying mechanism from the recording area to the roller in the n-th recording step, n-th being 2nd to x-th; and
a third determination process of determining a longer time from between the tentative standby time for the n-th recording step and a time obtained by subtracting a time from an end of a (n−1)-th recording step to an end of the n-th recording step from a standby time for the (n−1)-th recording step;
wherein the conveying process is performed after the standby time for a x-th recording step has elapsed from end of the x-th recording step.
